(19) United States
(12) Patent Application Publication
(10) Pub. No.: US 2026/0055876 A1
(43) Pub. Date: Feb. 26, 2026

(54) SPLIT-TYPE MOUNTING STRUCTURE FOR A CEILING LAMP AND CEILING LAMP

(71) Applicant: DONGGUAN JIASHENG LIGHTING TECHNOLOGY CO., LTD., Dongguan (CN)

(72) Inventor: Chih-pin HSU, Dongguan (CN)

(73) Assignee: DONGGUAN JIASHENG LIGHTING TECHNOLOGY CO., LTD., Dongguan (CN)

(21) Appl. No.: 19/372,231

(22) Filed: Oct. 28, 2025

(30) Foreign Application Priority Data
Sep. 3, 2025 (CN) 202521902419.6

(51) Int. Cl. F21V 21/03; F16M 13/02

(52) U.S. Cl. CPC F21V 21/03; F16M 13/027

(57) ABSTRACT

A split-type mounting structure for a ceiling lamp and a ceiling lamp are provided. The ceiling lamp is fixed onto the mounting surface via the split-type mounting structure. The split-type mounting structure includes a mounting groove disposed on the top of the ceiling lamp; a pivot portion fixed at one end of the mounting groove; a latching portion disposed at the other end of the mounting groove; and a mounting plate detachably connected to the mounting groove. The mounting plate includes a body adapted to a width of the mounting groove; a hook portion disposed at one end of the body, and detachably connected to the pivot portion, and the mounting plate is rotatably hinged to the pivot portion via the hook portion, and a snap-fit portion disposed at the other end of the body, and the snap-fit portion is detachably snap-fitted on the latching portion.

### TECHNICAL FIELD

The present disclosure relates to the technical field of ceiling lamps, and in particular to a split-type mounting structure for a ceiling lamp and a ceiling lamp.

### BACKGROUND

Ceiling lamps are a common type of lighting fixture. Their flat top surfaces enable them to fit snugly against a mounting surface (such as a ceiling or a roof). In this way, the ceiling lamp after installation provides a larger illumination space, ensuring sufficient brightness while saving power. Therefore, the ceiling lamps are widely used in both industrial field and daily life.

In the prior art, a ceiling lamp is generally installed by fixedly connecting a mounting structure on a top surface of the ceiling and a mounting surface. Therefore, for a relatively large ceiling lamp, a large mounting structure is often required to ensure the stability of installation. However, this installation structure requires wiring and installation to be carried out simultaneously. During installation, the user needs to hold the lamp with one hand and connect the wires with the other hand. For the ceiling lamp with relatively large weight and size, this makes the installation process difficult and inconvenient for a single person to perform.

Therefore, the prior art needs to be further improved and developed.

### SUMMARY

In view of the aforesaid deficiencies in the prior art, the present disclosure aims to provide a split-type mounting structure for a ceiling lamp and a ceiling lamp, so as to solve the problem in the prior art that ceiling lamps with larger size or weight are difficult to install and inconvenient for a single person to install.

The present disclosure adopts the following technical solutions:

In a first aspect, the present disclosure provides a split-type mounting structure for a ceiling lamp. The ceiling lamp is fixed onto a mounting surface via the split-type mounting structure. The split-type mounting structure includes:

a mounting groove, where the mounting groove is formed on a top surface of the ceiling lamp;

a pivot portion, where the pivot portion is fixed at one end of the mounting groove;

a latching portion, where the latching portion is disposed at the other end of the mounting groove; and

a mounting plate, where the mounting plate is detachably connected to the mounting groove, and the mounting plate includes:

a body, where the body is adapted to a width of the mounting groove;

a hook portion, where the hook portion is disposed at one end of the body, and the hook portion is detachably connected to the pivot portion, and the mounting plate is rotatably hinged to the pivot portion via the hook portion; and

a snap-fit portion, where the snap-fit portion is disposed at the other end of the body, and the snap-fit portion is detachably snap-fitted on the latching portion.

In one embodiment, the hook portion includes:

a hook, where the hook is detachably connected to the pivot portion, and the mounting plate is rotatably hinged to the pivot portion via the hook;

a connecting section, where the connecting section extends in a longitudinal direction of the body to connect the hook and the body; and

a limiting plate, where the limiting plate is disposed perpendicular to the connecting section to limit a rotation angle of the mounting plate when the mounting plate is rotated relative to the pivot portion.

In one embodiment, the hook portion is provided with two hooks arranged in parallel, and the two hooks are connected to the body through the two connecting sections respectively.

In one embodiment, the pivot portion includes:

a groove, where the groove is formed at an end of the mounting groove corresponding to the hook, and an extending direction of the groove is perpendicular to an extending direction of the mounting groove; and

a rotating shaft, where the rotating shaft is fixed in the groove and is arranged perpendicular to the extending direction of the groove and the mounting groove, the rotating shaft is detachably connected to the hook, and the hook cooperates with the rotating shaft to achieve a rotatable hinged connection between the hook and the rotating shaft.

In one embodiment, the hook includes:

a curved section, where the curved section is arranged to match a curvature of the rotating shaft to ensure a rotatable hinged connection between the mounting plate and the pivot portion after the hook is engaged with the rotating shaft; and

an extension section, where the extension section is tangent to the curved section to prevent the hook from disengaging from the rotating shaft when the mounting plate is rotated relative to the rotating shaft.

In one embodiment, the latching portion includes:

a movable body, where the movable body is adapted to the mounting groove and is slidable along the mounting groove between a first position and a second position;

a latching hook, where the latching hook is disposed on a side of the movable body facing the mounting plate, and the latching portion achieves a detachable connection with the mounting plate via the latching hook;

a return spring, where the return spring is disposed between the latching portion and the mounting groove to provide elastic force to drive the latching portion to move from the second position to the first position; and

an operating portion, where the operating portion is disposed on a side of the movable body and extends in a direction away from the mounting plate, and the operating portion protrudes from the mounting groove, facilitating the movement of the latching portion from the first position to the second position.

In an embodiment, the mounting groove includes:

a limiting block, where the limiting block is disposed at the second position perpendicular to a bottom surface of the mounting groove, and when the latching portion moves to the second position, the limiting block abuts against the latching portion, preventing further movement of the latching portion;

a sliding slot, where the sliding slot is formed on an inner sidewall of the mounting groove corresponding to the movable body, an extending direction of the sliding slot is parallel to the extending direction of the mounting groove, and two side edges of the movable body are latched within the sliding slot, enabling the movable body to slide freely along the mounting groove; and

a notch, where the notch is formed on the other end of the mounting groove corresponding to the operating portion, and when the latching portion is in the first position, the operating portion extends from the notch.

In one embodiment, the mounting plate further includes baffles, and the baffles are disposed perpendicularly to the body at both ends, such that after the mounting plate is fixed to the mounting surface, a gap for hanging the ceiling lamp is reserved between the mounting plate and the mounting surface.

In one embodiment, a through hole is formed at a central position of the body corresponding to the ceiling lamp, allowing electrical wires to pass through the through hole to supply power to the ceiling lamp after the ceiling lamp is installed on the mounting surface.

In a second aspect, the present disclosure provides a ceiling lamp, including the split-type mounting structure for ceiling lamp as described in any of the above embodiments.

The present disclosure provides a split-type mounting structure for a ceiling lamp and a ceiling lamp. The ceiling lamp is fixed onto the mounting surface via the split-type mounting structure. The split-type mounting structure includes a mounting groove disposed on the top of the ceiling lamp; a pivot portion fixed at one end of the mounting groove; a latching portion disposed at the other end of the mounting groove; and a mounting plate detachably connected to the mounting groove. The mounting plate includes a body adapted to the width of the mounting groove; a hook portion disposed at one end of the body, and detachably connected to the pivot portion, and the mounting plate is rotatably hinged to the pivot portion via the hook portion, and a snap-fit portion disposed at the other end of the body, and the snap-fit portion is detachably snap-fitted on the latching portion. By adopting the split-type mounting structure, the ceiling lamp can first be suspended from the mounting plate after the mounting plate is fixed onto the mounting surface, wiring can be completed, and the ceiling lamp is then fully installed, thereby reducing the difficulty of installation and allowing a single person to complete the installation.

### BRIEF DESCRIPTION OF THE DRAWINGS

FIG. 1 is a perspective view of a ceiling lamp with a split-type mounting structure fixing a mounting plate within the mounting groove according to the present disclosure.

FIG. 2 is a perspective view of a ceiling lamp with a split-type mounting structure rotated to an angle relative to a ceiling lamp according to the present disclosure.

FIG. 3 is a perspective view of a ceiling lamp with a split-type mounting structure rotated to an angle relative to a ceiling lamp according to the present disclosure from another angle.

FIG. 4 is an exploded view of a ceiling lamp provided with a split-type mounting structure according to the present disclosure.

FIG. 5 is a front cross-sectional view of a latching portion in a first position according to the present disclosure.

FIG. 6 is a front cross-sectional view of a latching portion in a second position according to the present disclosure.

FIG. 7 is a perspective view of a mounting plate according to the present disclosure.

FIG. 8 is an enlarged schematic diagram of position A in FIG. 7.

### DETAILED DESCRIPTIONS OF THE EMBODIMENTS

The present disclosure provides a split-type mounting structure for a ceiling lamp. In order to make the objectives, technical solutions, and effects of the present disclosure clearer, the present disclosure will be further described in detail below. It should be understood that the specific embodiments described herein are merely used to explain the present disclosure and are not intended to limit the present disclosure.

It should be noted that the terms “center”, “upper”, “lower”, “left”, “right”, “inner”, “outer”, “vertical”, “horizontal”, etc. indicate azimuthal or positional relations on the basis of those shown in the drawings only for ease of description of the present disclosure and for simplicity of description, and are not intended to indicate or imply that the referenced structure must have a particular orientation and be constructed in a particular orientation, and thus may not be construed as a limitation on the present disclosure.

In addition, unless otherwise specified for the articles in the context, “a/an” and “the” can generally refer to either a single or multiple instances. Under the condition that embodiments of the present disclosure involve descriptions of “first”, “second”, etc., the descriptions of “first”, “second”, etc. are for descriptive purposes only and are not to be construed as indicating or implying their relative importance or implicitly specifying the number of indicated technical features. Thus, a feature defined with “first” and “second” may explicitly or implicitly include at least one of the features. In addition, the technical solutions of the embodiments may be combined with one another, which must be based on the achievement by those of ordinary skill in the art, and when the combinations of the technical solutions contradict one another or cannot be achieved, it should be considered that the combinations of the technical solutions do not exist and do not fall within the scope of protection claimed in the present disclosure.

In order to ensure installation stability for a ceiling lamp of relatively large size and weight, a relatively large mounting structure is usually required for fixation. However, this design with a large mounting structure further increases a weight of the ceiling lamp, thereby making transportation and storage more difficult. In addition, conventional mounting structures require the user to perform installation and wiring simultaneously. Therefore, for the ceiling lamp of larger size or weight, it usually requires a user to hold the ceiling lamp with one hand while performs the wiring with the other hand, followed by installation of the ceiling lamp. This installation process is cumbersome and inconvenient for a single person to complete. When a single person attempts to install the ceiling lamp alone, it is easy for the ceiling lamp to become unstable during wiring, which may cause the ceiling lamp to fall, tearing the wires or even damaging the ceiling lamp.

Therefore, the present disclosure provides a split-type mounting structure for a ceiling lamp and a ceiling lamp. The split-type mounting structure includes a mounting groove formed on a top surface of the ceiling lamp and a mounting plate detachably connected to the ceiling lamp. One end of the mounting plate is detachably connected and pivotally hinged to the ceiling lamp, and the other end is detachably latched to the ceiling lamp. In this way, when not in use, the mounting plate can be separated from the ceiling lamp for independent storage and transportation. When the ceiling lamp needs to be installed, the mounting plate can first be installed to a mounting surface, and the ceiling lamp can then be pivotally hinged to the mounting plate and suspended from the mounting plate. This frees the user’s hands to complete wiring of the ceiling lamp, after which the ceiling lamp can be pushed to be latched into the other end of the mounting plate, thereby quickly completing installation of the ceiling lamp to the mounting surface. This allows the installation process to be completed by a single person, reducing installation difficulty and improving the user experience.

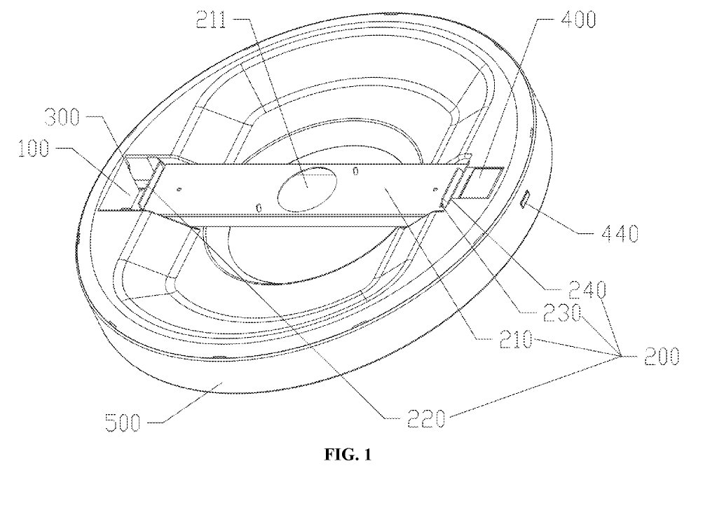

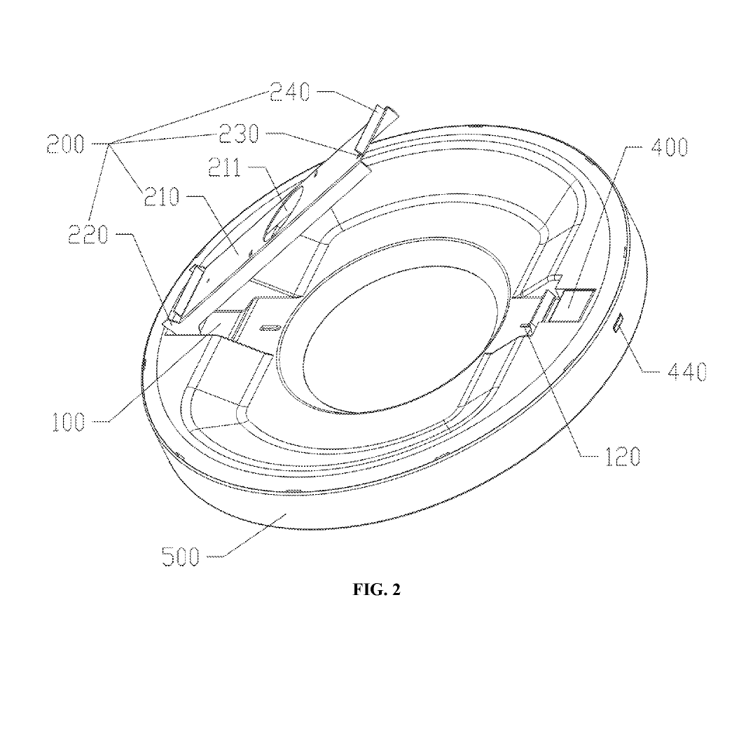

Specifically, the present disclosure provides a split-type mounting structure for a ceiling lamp and a ceiling lamp. As shown in FIGS. 1 and 2, a ceiling lamp 500 disclosed in the present disclosure is provided with a split-type mounting structure at its top. The split-type mounting structure includes a mounting groove 100 formed in a surface of the ceiling lamp 500, a pivot portion 300 and a latching portion 400 respectively disposed at opposite ends of the mounting groove 100, and a mounting plate 200 detachably and pivotally hinged to the ceiling lamp 500 via the pivot portion 300 and the latching portion 400. By means of the mounting groove 100, the mounting plate 200, the pivot portion 300, and the latching portion 400, the split-type mounting structure is arranged at a top of the ceiling lamp 500, thereby fixing the ceiling lamp 500 to the mounting surface and completing the installation of the ceiling lamp 500. All components of the split-type mounting structure are completely concealed within a top inner side of the ceiling lamp 500 and are not exposed outside the ceiling lamp 500 after installation, thereby ensuring the overall aesthetic appearance while preventing damage during use.

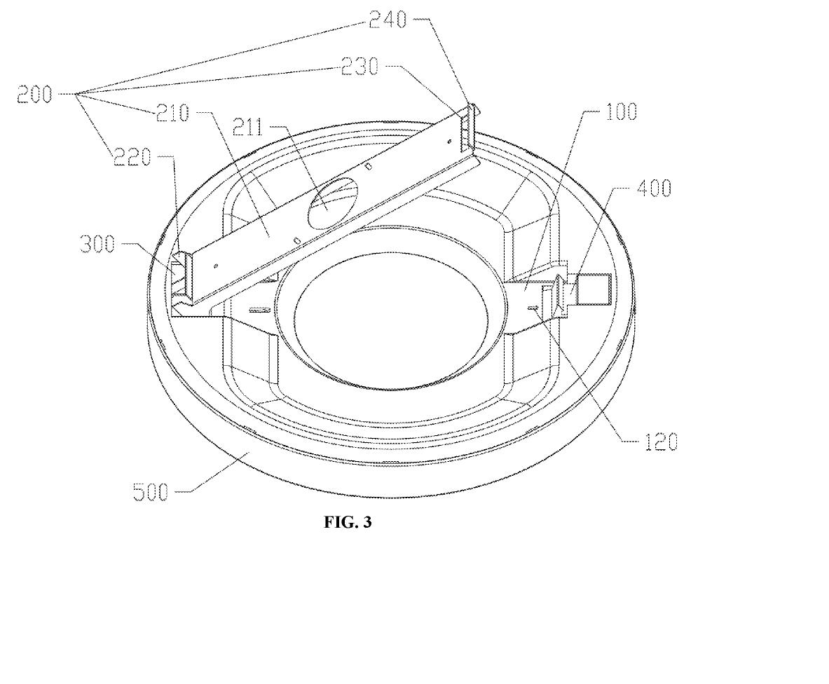

Further, as shown in FIGS. 3, 4 and 5, one end of the mounting plate 200 is detachably connected and pivotally hinged to the pivot portion 300, that is, when the mounting plate 200 and the pivot portion 300 are connected, the ceiling lamp 500 may be rotated relative to the mounting plate 200 via the pivot portion 300, ensuring that after the mounting plate 200 is fixed to the mounting surface, the ceiling lamp 500 can first be suspended from the mounting plate 200 via the pivot portion 300, freeing the user’s hands to complete wiring of the ceiling lamp 500. Further, the other end of the mounting plate 200 is detachably connected to the latching portion 400, that is, after one end of the mounting plate 200 is hinged to the pivot portion 300, when the ceiling lamp 500 is rotated until its top surface abuts against the mounting plate 200, the other end of the mounting plate 200 can be latched to the latching portion 400, such that a surface of the ceiling lamp 500 forms a flat surface without protrusions, ensuring that there is no gap between the ceiling lamp and the mounting surface after the ceiling lamp 500 is fixed to the mounting surface, and the mounting plate 200 is completely concealed inside the ceiling lamp 500.

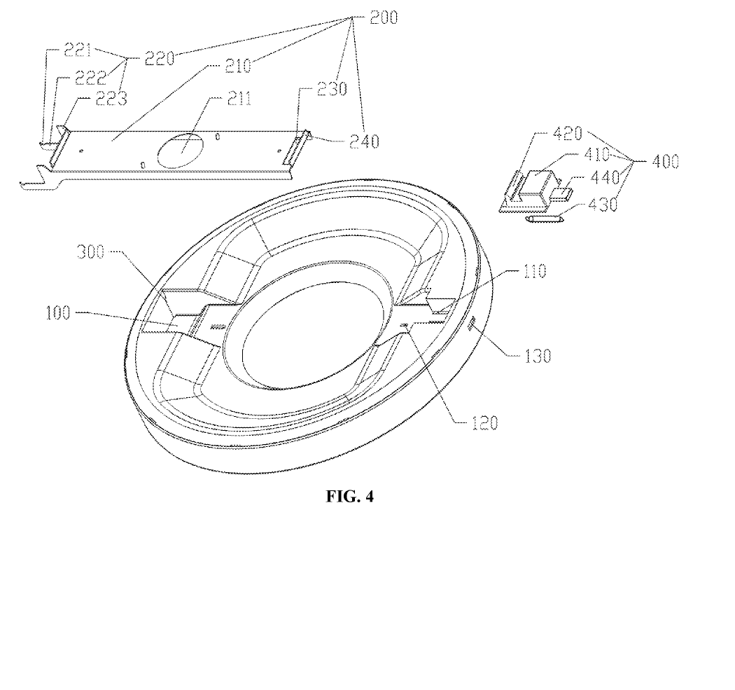

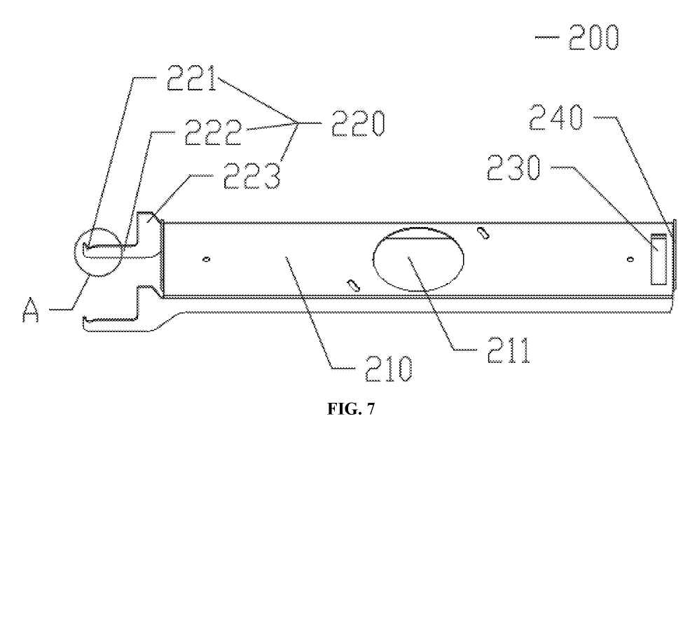

Further, as shown in FIGS. 4 and 7, the mounting plate 200 includes a body 210, a hook portion 220, and a snap-fit portion 230. The body 210 forms an entire plate-like structure of the mounting plate 200, and a through hole 211 is formed at a central position of the body 210 corresponding to the ceiling lamp 500. After the ceiling lamp 500 is fixed to the mounting surface via the split-type mounting structure, electrical wires pass through the through hole 211 to connect the ceiling lamp 500 to an external power source, thereby ensuring power supply to the ceiling lamp 500. Specifically, after the mounting plate 200 is fixed to the mounting surface, the ceiling lamp 500 is suspended from one end of the mounting plate 200, and then the electrical wires pass through the through hole 211 to be connected to the ceiling lamp 500. This connection process is simple and quick, convenient for a single person to operate. Optionally, the mounting groove 100 may form a clearance notch at a middle position corresponding to the body 210, thereby facilitating the user to grasp the body 210 for rotating the mounting plate 200.

Further, as shown in FIG. 7, the hook portion 220 is disposed at one end of the body 210, and the snap-fit portion 230 is disposed at the other end of the body 210, that is, the snap-fit portion 230 and the hook portion 220 are disposed at opposite ends of the body 210, ensuring that the mounting plate 200 enables the body 210 to be detachably hinged to the ceiling lamp 500 via the hook portion 220. In addition, after the mounting plate 200 is hinged to the ceiling lamp 500, the mounting plate 200 may be latched to the ceiling lamp 500 via the snap-fit portion 230. Therefore, after the mounting plate 200 is fixed to the mounting surface, the ceiling lamp 500 is first hinged to the mounting plate 200 and suspended from the mounting plate 200. After wiring is completed, the ceiling lamp 500 is rotated relative to the mounting plate 200 until the ceiling lamp 500 is pushed into a position parallel to the mounting plate 200, the mounting plate 200 is then latched to the ceiling lamp 500, and the mounting plate 200 is completely concealed inside the top of the ceiling lamp 500, completing the installation. This ensures the overall aesthetic appearance of the ceiling lamp 500 while preventing damage to the split-type mounting structure during use.

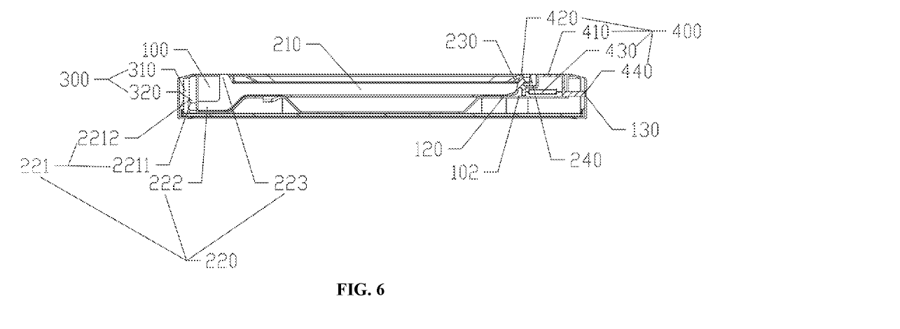

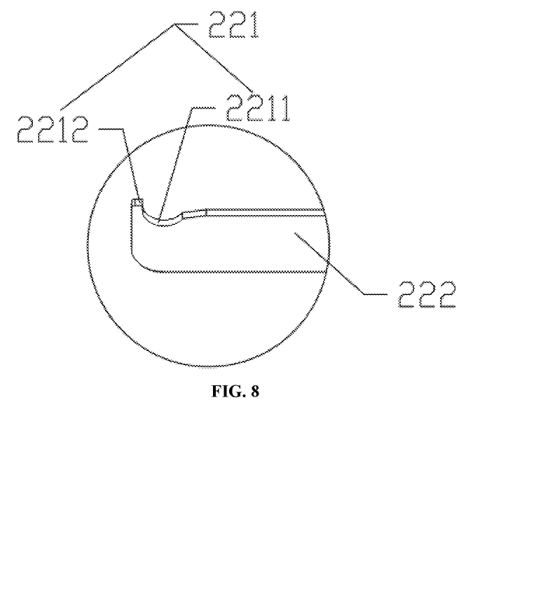

Further, as shown in FIGS. 1 and 3, the hook portion 220 is disposed at an end of the body 210 facing the pivot portion 300 to form a detachable hinge structure with the pivot portion 300, thereby achieving a detachable connection and rotatable hinging between the mounting plate 200 and the ceiling lamp. The hook portion 220 includes a connecting section 222 connected to the body 210, a limiting plate 223 disposed perpendicular to the connecting section 222, and a hook 221 disposed at an end of the connecting section 222 distal to the body 210. Specifically, the connecting section 222 extends in a longitudinal direction of the body 210 such that the hook 221 protrudes toward the pivot portion 300. The limiting plate 223 is disposed at a position where the connecting section 222 is connected to the body 210 and is perpendicular to both the connecting section 222 and the body 210, so as to limit a rotation angle of the ceiling lamp 500 when the ceiling lamp 500 is rotated relative to the mounting plate 200, thereby preventing the ceiling lamp 500 from falling off the mounting plate 200. Specifically, the limiting plate 223 cooperates with the top of the ceiling lamp 500 to limit the rotation angle between the mounting plate 200 and the top surface of the ceiling lamp 500 to 0-90°. Further, as shown in FIGS. 6 and 8, the hook 221 includes a curved section 2211 connected to the connecting section 222, and an extension section 2212 disposed at the other end of the curved section 2211 opposite to the connecting section 222 and tangent to the curved section 2211. A curvature of the curved section 2211 is adapted to a rotating shaft 320 in the pivot portion 300, ensuring that the hook 221 can hang onto the rotating shaft 320 through the curved section 2211 and rotate smoothly about the rotating shaft 320. The extension section 2212 extends from the curved section 2211 into a gap between the rotating shaft 320 and the mounting groove 100, such that during rotation of the hook 221 relative to the rotating shaft 320, the extension section 2212 always remains on an opposite side of the rotating shaft 320 relative to the mounting plate 200, preventing the mounting plate 200 from disengaging from the pivot portion 300 during rotation, and ensuring the operational stability of the split-type mounting structure. Further, when wiring the ceiling lamp 500, the ceiling lamp 500 may be hung on the hook 221, thereby freeing the user’s hands to complete the wiring work, making it convenient for a single person to operate.

Optionally, in one embodiment, the hook portion 220 includes two connecting sections 222 arranged in parallel, with one hook 221 at an end of each connecting section 222 away from the mounting plate 200. A distance between the two connecting sections 222 is equal to a width of the mounting plate 200, and each can correspond to the rotating shaft 320 in the pivot portion 300 to form a hinged structure, such that the mounting plate 200 is stably hinged to the pivot portion 300. This prevents the ceiling lamp 500 from tilting when suspended from the mounting plate 200 and prevents deviation when the ceiling lamp 500 rotates relative to the mounting plate 200, thereby improving the stability of the split-type mounting structure.

Further, as shown in FIGS. 2 and 3, the mounting plate 200 further includes a pair of baffles 240. The baffles 240 extend upward perpendicular to both ends of the body 210 to ensure that after the mounting plate 200 is fixed to the mounting surface, a gap is kept between the hook portion 220 of the mounting plate 200 and the mounting surface, facilitating the hanging of the ceiling lamp 500 on the hook portion 220.

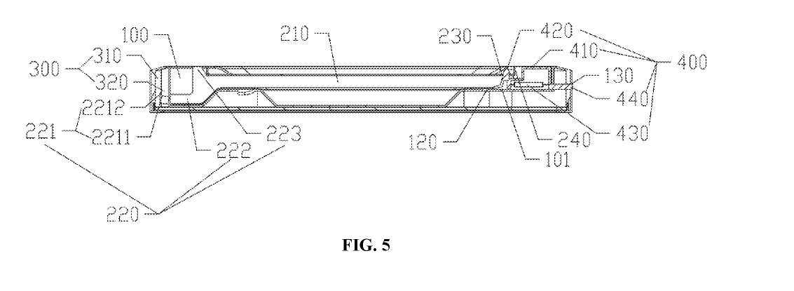

Further, as shown in FIGS. 3 and 5, the snap-fit portion 230 is disposed at an end of the body 210 facing the latching portion 400. When the hook portion 220 is stably hinged and connected to the pivot portion 300, and the mounting plate 200 is rotated relative to the pivot portion 300 into the mounting groove 100, the snap-fit portion 230 can form a snap-fit connection with the latching portion 400 to fix the mounting plate 200, this completely conceals the mounting plate 200 in the mounting groove 100, thereby preventing the mounting plate 200 from being exposed outside the ceiling lamp 500 and improving safety during use. Specifically, the snap-fit portion 230 is a snap-fit structure extending through The mounting plate 200 to match the latching hook 420 in the latching portion 400 to form a stable snap-fit connection. Further, when the ceiling lamp 500 is pushed to engage with the mounting plate 200, the snap-fit portion 230 presses against a top of the latching hook 420, driving the latching portion 400 to move and enable the ceiling lamp 500 to latch to the mounting plate 200.

Further, as shown in FIGS. 3 and 4, the mounting groove 100 is a strip-shaped groove, and the pivot portion 300 and the latching portion 400 are arranged at opposite ends of the mounting groove 100. In one embodiment, the ceiling lamp is a circular ceiling lamp, and the mounting groove is located at a diameter of the top surface of the ceiling lamp. The pivot portion 300 and the latching portion 400 are arranged inside the ceiling lamp, ensuring that the mounting plate 200 is completely concealed inside the top surface of the ceiling lamp when the mounting plate 200 is accommodated in the mounting groove 100, avoiding structural exposure outside the ceiling lamp, thereby improving overall aesthetics and operational stability.

Specifically, as shown in FIGS. 5 and 6, the pivot portion 300 includes a groove 310 and a rotating shaft 320. The groove 310 is formed at an end of the mounting groove 100 corresponding to the hook 221, and an extending direction of the groove 310 is perpendicular to an extending direction of the mounting groove 100. In one embodiment, the mounting groove 100 extends along the top surface of the ceiling lamp, and the groove 310 extends perpendicular to the top surface of the ceiling lamp. Further, a rotating shaft 320 parallel to the top surface of the ceiling lamp is arranged in the groove 310, that is, the rotating shaft 320 is perpendicular to the extending direction of the groove 310 and the rotating shaft 320 is perpendicular to the extending direction of the mounting groove 100, thereby forming a pivot structure adapted to the hook portion 220 on the mounting plate 200. In one embodiment, the mounting groove 100 corresponds to the hook portion 220, a plurality of grooves 310 corresponding to the numbers and positions of the connecting sections 222 and hooks 221 are arranged. When the mounting plate 200 is connected to the ceiling lamp, the hooks 221 are inserted into the corresponding grooves 310 and engage with the rotating shafts 320 to form a stable hinged structure, achieving a pivotally hinged connection between the mounting plate 200 and the ceiling lamp, such that the ceiling lamp is suspended from the mounting plate 200 via the cooperation of the rotating shafts 320 and the hooks 221. The cooperation of the plurality of rotating shafts 320 and the plurality of hooks 221 ensures that the ceiling lamp does not tilt when being suspended from the mounting plate 200 and does not deviate during rotation, thereby improving the stability of the split-type mounting structure during use.

Specifically, as shown in FIGS. 5 and 6, the latching portion 400 is movable between a first position 101 and a second position 102 within the mounting groove 100. When the mounting plate 200 is rotated to be accommodated in the mounting groove 100, and the latching portion 400 is in the first position 101, the latching portion 400 is latched to the snap-fit portion 230 of the mounting plate 200 to fix the mounting plate 200 within the mounting groove 100. When the latching portion 400 is in the second position 102, the latching portion 400 is disengaged from the snap-fit portion 230 of the mounting plate 200, allowing the ceiling lamp to rotate relative to the mounting plate 200 under gravity, thereby providing a sufficient space for quickly disconnecting the wiring of the ceiling lamp and separating the ceiling lamp from the mounting plate 200. In one embodiment, a raised limiting block 120 is disposed at the second position 102 of the mounting groove 100. When the latching portion 400 moves to the second position 102, the limiting block 120 abuts against the latching portion 400, preventing the latching portion 400 from further moving and falling off the mounting groove 100.

Further, as shown in FIGS. 4 and 5, the latching portion 400 includes a movable body 410, a latching hook 420, a return spring 430, and an operating portion 440. The movable body 410 is adapted to the mounting groove 100 and can slide along the mounting groove 100 between the first position 101 and the second position 102. The latching hook 420 is disposed on a side of the movable body 410 facing the mounting plate 200, enabling the latching portion 400 to form a detachable connection with the mounting plate 200 via the latching hook 420. The return spring 430 is disposed between the latching portion 400 and the mounting groove 100, providing restoring force to drive the latching portion 400 from the second position 102 to the first position 101. The operating portion 440 is disposed on the movable body 410 and extends in a direction away from the mounting plate 200. The operating portion 440 protrudes from the mounting groove 100 to facilitate the movement of the latching portion 400 from the first position 101 to the second position 102. Specifically, the latching hook 420 has an inclined surface on its top. When the ceiling lamp is rotated to allow the mounting plate 200 to accommodate within the mounting groove 100, the snap-fit portion 230 of the mounting plate 200 presses against the inclined surface at the top of the latching hook 420, pushing the latching portion 400 to move from the first position 101 to the second position 102. After the snap-fit connection is completed, the latching portion 400 is restored to the first position 101 under the action of the return spring 430, thereby completing the snap-fit connection between the latching portion 400 and the mounting plate 200.

Specifically, as shown in FIGS. 3 and 4, at the end of the mounting groove 100 corresponding to the latching portion 400, sliding slots 110 are formed on both sides of the movable body 410 corresponding to the mounting groove 100. The sliding slots 110 extend in the same direction as the mounting groove 100 and are slightly wider than heights of both sides of the movable body 410, such that the movable body 410 is inserted into the sliding slots 110 and the movable body 410 can freely slide along the sliding slots 110, ensuring that the latching portion 400 can move between the first position 101 and the second position 102 while preventing the latching portion 400 from falling off the mounting groove 100, thereby improving safety and stability during use.

Further, as shown in FIGS. 4 and 6, the mounting groove 100 has a notch 130 formed in a side wall corresponding to the operating portion 440. When no external force is applied to the latching portion 400, the return spring 430 provides restoring force to fix the movable body 410 in the first position 101, in which case, the operating portion 440 protrudes from the notch 130 to form a structure on a side wall of the ceiling lamp that can drive the latching portion 400 to move. When the user presses the operating portion 440 within the notch 130, the latching portion 400 can be moved from the first position 101 to the second position 102, such that the latching portion 400 is disengaged from the mounting plate 200. When the operating portion 440 is released, the return spring pushes the latching portion 400 back to the first position 101, with the operating portion 440 again protruding from the notch 130 for subsequent operation by the user.

In conjunction with the split-type mounting structure, the present disclosure further provides a ceiling lamp, where the ceiling lamp is provided with the aforesaid split-type mounting structure, enabling quick installation and removal of the ceiling lamp and the split-type mounting structure, thereby facilitating transportation and storage. In addition, the connecting portions of the split-type mounting structure with the ceiling lamp are concealed within the mounting groove on an inner side of the top surface of the ceiling lamp, preventing the connecting portions from being exposed outside the ceiling lamp, thereby ensuring overall visual aesthetics and preventing damage to the connecting portions during use.

A use process of the ceiling lamp with the split-type mounting structure is briefly described as follows:

During transportation and storage, the ceiling lamp and the mounting plate of the split-type mounting structure are in a separated configuration. The mounting groove, pivot portion, and latching portion of the split-type mounting structure are all arranged within the top surface of the ceiling lamp. When the ceiling lamp needs to be installed, the mounting plate is first fixed to the mounting surface, the hooks of the hook portion are then inserted into the grooves of the pivot portion and engaged with the rotating shafts within the grooves to form a hinged structure, the ceiling lamp is suspended from the mounting plate, and the ceiling lamp can rotate relative to the mounting plate. After the ceiling lamp is suspended from the mounting plate, wires pass through the through holes in the body of the mounting plate and electrically connected to the ceiling lamp to supply power to the ceiling lamp. The ceiling lamp is then rotated relative to the mounting plate until the mounting plate is completely accommodated within the mounting groove, in which case, the snap-fit portion of the mounting plate is snap-fitted on the latching hook of the latching portion, the ceiling lamp is installed to the mounting surface. The split-type mounting structure is completely concealed within the top of the ceiling lamp, with no structure exposed outside, thereby ensuring the overall aesthetics of the ceiling lamp. The installation process is simple and rapid, allowing a single person to complete both the installation and wiring.

When the ceiling lamp needs to be removed, the notch on the side wall of the top surface of the ceiling lamp is located, and the operating portion within the notch is pressed to enable the latching portion to be disengaged from the snap-fit portion of the mounting plate. Since the hook portion of the mounting plate remains engaged with the pivot portion, the ceiling lamp rotates relative to the mounting plate under gravity, in which case, the ceiling lamp is rotated relative to the mounting plate to a suitable angle under the limitation of the limiting plate of the hook portion on the mounting plate, preventing the ceiling lamp from completely disengaging from the mounting plate, in which case, the ceiling lamp is suspended from the mounting plate. After the ceiling lamp is disconnected from the electrical wires, the hooks within the hook portion are disengaged from the rotating shafts inside the pivot portion, and the ceiling lamp is then removed from the mounting plate, facilitating subsequent replacement or reinstallation. Finally, the mounting plate is removed from the mounting surface, completing the disassembly process. The mounting plate and the ceiling lamp can be stored or transported separately.

In summary, the present disclosure provides a split-type mounting structure for a ceiling lamp and a ceiling lamp. The ceiling lamp is fixed onto the mounting surface via the split-type mounting structure. The split-type mounting structure includes a mounting groove disposed on the top of the ceiling lamp; a pivot portion fixed at one end of the mounting groove; a latching portion disposed at the other end of the mounting groove; and a mounting plate detachably connected to the mounting groove. The mounting plate includes a body adapted to the width of the mounting groove; a hook portion disposed at one end of the body, and detachably connected to the pivot portion, and the mounting plate is rotatably hinged to the pivot portion via the hook portion, and a snap-fit portion disposed at the other end of the body, and the snap-fit portion is detachably snap-fitted on the latching portion. By adopting the split-type mounting structure, the ceiling lamp can first be suspended from the mounting plate after the mounting plate is fixed onto the mounting surface, wiring can be completed, and the ceiling lamp is then fully installed, thereby reducing the difficulty of installation and allowing a single person to complete the installation.

It should be understood that the application of the present disclosure is not limited to the above examples. For those ordinarily skilled in the art, improvements or variations can be made based on the foregoing description, and all these improvements or variations shall fall within the scope of protection of the appended claims of the present disclosure.

What is claimed is:

1. A split-type mounting structure for a ceiling lamp, wherein the ceiling lamp is fixed onto a mounting surface via the split-type mounting structure, and the split-type mounting structure comprises:
a mounting groove, wherein the mounting groove is formed on a top surface of the ceiling lamp;
a pivot portion, wherein the pivot portion is fixed at one end of the mounting groove;
a latching portion, wherein the latching portion is disposed at the other end of the mounting groove; and
a mounting plate, wherein the mounting plate is detachably connected to the mounting groove, and the mounting plate comprises:
a body, wherein the body is adapted to a width of the mounting groove;
a hook portion, wherein the hook portion is disposed at one end of the body, and the hook portion is detachably connected to the pivot portion; and the mounting plate is rotatably hinged to the pivot portion via the hook portion; and
a snap-fit portion, wherein the snap-fit portion is disposed at the other end of the body, and the snap-fit portion is detachably snap-fitted on the latching portion.

2. The split-type mounting structure for a ceiling lamp according to claim 1, wherein the hook portion comprises:
a hook, wherein the hook is detachably connected to the pivot portion, and the mounting plate is rotatably hinged to the pivot portion via the hook;
a connecting section, wherein the connecting section extends in a longitudinal direction of the body to connect the hook and the body; and
a limiting plate, wherein the limiting plate is disposed perpendicular to the connecting section to limit a rotation angle of the mounting plate when the mounting plate is rotated relative to the pivot portion.

3. The split-type mounting structure for a ceiling lamp according to claim 2, wherein the hook portion is provided with two hooks arranged in parallel, and the two hooks are connected to the body through the two connecting sections, respectively.

4. The split-type mounting structure for a ceiling lamp according to claim 2, wherein the pivot portion comprises:
a groove, wherein the groove is formed at an end of the mounting groove corresponding to the hook, and an extending direction of the groove is perpendicular to an extending direction of the mounting groove; and
a rotating shaft, wherein the rotating shaft is fixed in the groove and is arranged perpendicular to the extending direction of the groove and the mounting groove, the rotating shaft is detachably connected to the hook, and the hook cooperates with the rotating shaft to achieve a rotatable hinged connection between the hook and the rotating shaft.

5. The split-type mounting structure for a ceiling lamp according to claim 4, wherein the hook comprises:
a curved section, wherein the curved section is arranged to match a curvature of the rotating shaft to ensure a rotatable hinged connection between the mounting plate and the pivot portion after the hook is engaged with the rotating shaft; and
an extension section, wherein the extension section is tangent to the curved section to prevent the hook from disengaging from the rotating shaft when the mounting plate is rotated relative to the rotating shaft.

6. The split-type mounting structure for a ceiling lamp according to claim 1, wherein the latching portion comprises:
a movable body, wherein the movable body is adapted to the mounting groove and is slidable along the mounting groove between a first position and a second position;
a latching hook, wherein the latching hook is disposed on a side of the movable body facing the mounting plate, and the latching portion achieves a detachable connection with the mounting plate via the latching hook;
a return spring, wherein the return spring is disposed between the latching portion and the mounting groove to provide elastic force to drive the latching portion to move from the second position to the first position; and
an operating portion, wherein the operating portion is disposed on a side of the movable body and extends in a direction away from the mounting plate, and the operating portion protrudes from the mounting groove, facilitating the movement of the latching portion from the first position to the second position.

7. The split-type mounting structure for a ceiling lamp according to claim 6, wherein the mounting groove comprises:
a limiting block, wherein the limiting block is disposed at the second position perpendicular to a bottom surface of the mounting groove; and when the latching portion moves to the second position, the limiting block abuts against the latching portion, preventing further movement of the latching portion;
a sliding slot, wherein the sliding slot is formed on an inner sidewall of the mounting groove corresponding to the movable body, an extending direction of the sliding slot is parallel to the extending direction of the mounting groove, and two side edges of the movable body are latched within the sliding slot, enabling the movable body to slide freely along the mounting groove; and
a notch, wherein the notch is formed on the other end of the mounting groove corresponding to the operating portion, and when the latching portion is in the first position, the operating portion extends from the notch.

8. The split-type mounting structure for a ceiling lamp according to claim 6, wherein the mounting plate further comprises baffles, and the baffles are disposed perpendicularly to the body at both ends of the body; and when the mounting plate is fixed to the mounting surface, a gap for hanging the ceiling lamp is reserved between the mounting plate and the mounting surface.

9. The split-type mounting structure for a ceiling lamp according to claim 1, wherein a through hole is formed at a central position of the body corresponding to the ceiling lamp, allowing electrical wires to pass through the through hole to supply power to the ceiling lamp after the ceiling lamp is installed on the mounting surface.

10. A ceiling lamp, comprising the split-type mounting structure for a ceiling lamp according to claim 1.
